(19) United States
(12) Patent Application Publication
(10) Pub. No.: US 2004/0250900 A1
(43) Pub. Date: Dec. 16, 2004

(54) Apparatus for longitudinally orienting elongated wood strands

(75) Inventor: Matthias Graf, Bretten (DE)

Correspondence Address: FASSE PATENT ATTORNEYS, P.A., P.O. BOX 726, HAMPDEN, ME, 04444-0726, US

(73) Assignee: Dieffenbacher GmbH & Co. KG, Eppingen (DE)

(21) Appl. No.: 10/833,407

(22) Filed: Apr. 27, 2004

(30) Foreign Application Priority Data
May 9, 2003 (DE) 103 21 116.0

(51) Int. Cl. B27C 1/12

(52) U.S. Cl. 144/242.1

(57) ABSTRACT

Elongated strands, particularly wood strands, are deposited on a molding belt or a conveyor belt so that the strands are longitudinally oriented relative to each other for manufacturing panels known as oriented strand boards. For this purpose the strands are discharged onto an alignment mechanism or head that has a plurality of rotation shafts each carrying a plurality of disks axially spaced from one another along the respective shaft. These disks form alignment channels when the shafts rotate. Each channel or channel section is further subdivided into strand alignment chambers by a plurality of paddle elements. Preferably four such paddle elements are mounted to the respective rotation shaft between two neighboring disks thereby forming four pass through chambers between two neighboring disks.

### PRIORITY CLAIM

This application is based on and claims the priority under 35 U.S.C. §119 of German Patent Application 103 21 116.0, filed on May 9, 2003, the entire disclosure of which is incorporated herein by reference.

1. Field of the Invention

The invention relates to the longitudinal orientation or alignment of elongated wood strands, particularly for producing panels in which the wood strands are pre-oriented. Such panels are known as OSB panels or as oriented strand boards which have a higher material strength than regular chip boards.

2. Background Information

For manufacturing OSB panels long wood strands are deposited on a mold belt which is a conveyor belt that transports the oriented strands to a panel pressing operation. Conventionally, these wood strands have a length A of about 100 to 150 mm, a width B of about 10 to 30 mm, and a thickness C of about 0.4 to 1.0 mm. Conventionally, OSB panels have, as a rule, a three layer construction. However, recently five layer panels have also been produced in order to use different types of adhesive systems.

The wood strands of OSB-panels having a three layer structure are oriented crosswise in the central or middle layer relative to the strand orientation in the two outer layers. In the outer layers the strands are oriented longitudinally. This orientation or arrangement of the elongated wood strands results in anisotropic characteristics of the panels, particularly anisotropic strength characteristics. It is known that wood has a substantially higher material strength in the fiber orientation direction than in the direction crosswise to the fiber orientation. The arrangement of longitudinally oriented wood strands in the outer cover layers results in a high bending strength of the panel. When the panel is exposed to bending loads in the longitudinal panel direction, the longitudinally oriented strands are exposed to tension stress and to compression stress. A still acceptable or sufficient bending strength is achieved for the panels in the cross direction by the crosswise orientation of the strands in the center layer.

Experiments have shown that the quality of the longitudinal orientation of the wood strands has a very large influence on the bending strength of the panels in the longitudinal direction. It has been found that a deviation of merely 10 to 15° of the strand orientation from the longitudinal axis of the panel leads to noticeably lower strength characteristics.

In order to achieve a longitudinal strand orientation it is conventional to use so-called strand spreaders that employ different types of mechanisms for the orientation of the wood strands. Thus, for example, European Patent Publication EP 0,175,015 discloses a disk mechanism for the longitudinal orientation of wood strands. Such mechanisms are known as disk orienters.

Such disk orienters comprise a multitude of rotation shafts that are arranged crosswise to and above a molding or conveyor belt on which the strands are to be deposited. Each of these rotation shafts carries a plurality of thin sheet metal disks which are axially spaced from one another along the respective shaft and which extend in parallel to each other. The rotation shafts with their disks extend horizontally above the molding belt. The disks on neighboring shafts overlap each other in the feed advance direction and form longitudinally extending channels through which the wood strands fall. These channels are referred to herein as strand pass through channels or simply as channels.

The conventional disk orienters function on the principle that the strand pass through channels are narrower than the length of the wood strands so that the wood strands cannot pass through the channels with a crosswise strand orientation. The wood strands which contact the disk orienter and do not immediately pass through the channels are oriented by the rotational motion of the disk rollers, all of which rotate in the same direction, thereby moving the strands until they change their orientation to a substantially longitudinal orientation, whereby the stands become able to fall through or pass through the slots formed by the pass through channels.

System depending deviations of the strands from the longitudinal orientation occur in these disk orienters that function under the above described principle. On the one hand, the wood strands can fall through the slots in different orientations in all three directions of space. For example, when a strand has the dimensions of 100×20×0.5 mm, such a strand can fall through a slot having a 30 mm width in such a way that the leading edge of 20×0.5 mm points downwardly while the side edge of 100 mm×0.5 mm or the surface of 100 mm×20 mm is longitudinally oriented. Any random combination of strand orientations may occur which deviate from a desirable or ideal longitudinal alignment. This deviating orientation depends on how a strand falls through the channels or slot and the deviation can be larger or smaller relative to the ideal longitudinal alignment.

On the other hand, it may occur that the disk orienter is positioned at a fixed spacing from the molding belt. Thus, it is possible that a strand turns head-over-heels, so to speak, while falling through the pass through channels so that when hitting the molding belt the strands tip over and become oriented cross-wise. Such deposition of the wood strands leads to unwanted deviations of the longitudinal alignment of the wood strands from the longitudinal axis of the board to be formed. German Patent Publication DE OS 195 44 866 discloses another construction of a mechanical apparatus for the longitudinal orientation or rather alignment of wood strands. The known apparatus comprises a plurality of parallel, vertically oriented, stationary wall elements positioned next to each other. Elongated orientation elements are allocated to the wall elements. The orientation elements are connected to a drive and are thus capable of performing a strand aligning motion which includes a longitudinal motion component and a vertical motion component. Such a mechanism is quite involved, particularly with regard to driving a multitude of orientation elements so that the required motion components are performed.

German Utility Model Publication 297 07 143 discloses an apparatus for orienting and depositing of longitudinal particles. The known apparatus is constructed to improve the degree or quality of orientation of the particles while simultaneously assuring a high throughput capability. The known apparatus includes a mechanical orientation unit which comprises vertically positioned orientation surfaces aligned in the motion direction of a support on which the particles are to be deposited. Neighboring orientation surfaces are movable or drivable in opposite directions. The orientation or alignment surfaces move in parallel to the motion of the support on which the particles are to be deposited. Additionally, the alignment surfaces have motion components perpendicularly to the support for longitudinally orienting the particles such as wood strands The above described prior. art leaves room for improvement.

### OBJECTS OF THE INVENTION

In view of the foregoing it is the aim of the invention to achieve the following objects singly or in combination:

to improve an apparatus for the longitudinal orientation of elongated strands such as wood strands in such a manner that an exact longitudinal alignment of the strands is assured and individual strand deviations from the longitudinal orientations are prevented;

to prepare the strand alignment in such a way that the finished panels have improved strength characteristics, particularly with regard to the bending strength of the panels in the direction of the longitudinal panel axis;

to make sure that the wood strands arrive not only longitudinally oriented on the support belt, but also in a flat orientation with the large surface area of the strands parallel to the surface formed by the molding belt; and

to make sure that the strands are rotated for example by friction into the proper longitudinal alignment.

### SUMMARY OF THE INVENTION

The above objects have been achieved according to the invention in an apparatus which is characterized by an alignment mechanism including a plurality of rotation shafts arranged in parallel to one another above a molding belt or conveyor belt, wherein each of these rotation shafts carries a plurality of disks mounted for rotation with or on each rotation shaft. The disks are oriented at a right angle relative to a longitudinal shaft rotation axis and are spaced from each other along the respective rotation shaft, whereby two neighboring disks form a strand alignment pass through channel or channel section and all the disks together form a multitude of strand alignment pass through channels. In each of these channels there are mounted a plurality of paddle elements secured between neighboring disks, whereby the plurality of paddle elements form strand alignment chambers in the plurality of alignment channels.

The rotation shafts with their strand alignment chambers are referred to as chamber rollers. These chamber rollers with their paddle elements make sure that the wood strands to be oriented fall between axially spaced neighboring disks onto the paddle elements. Thus, the strands are forced to lie down, so to speak, on these paddle elements, thereby assuming a defined position relative to the longitudinal direction which corresponds to the feed advantage direction of the molding belt. As each of the chambers or rollers continues in its rotational motion, the respective wood strand begins, at a defined point, to slide off, beginning with its leading edge, the respective paddle element in the direction of the molding belt. When a strand has completely left its paddle element and has come to rest on the molding belt the large surface areas of a strand rest on the belt in parallel to the belt and longitudinally aligned therewith.

As the leading ends of the wood strands contact the molding or conveyor belt they are either subjected to a braking action or they are accelerated depending on the speed of the molding belt and the instantaneous speed of the individual wood strand at the time of contacting the molding belt. In both instances each wood strand assumes the speed of the molding belt and is thereby pulled off the respective paddle element. This pulling off feature of the invention has the advantage of further improving the longitudinal orientation of the wood strands because each strand now still rests temporarily with its trailing edge on the respective paddle element, whereby the friction tends to turn, or rather align the chip with its longitudinal axis to the longitudinal feed advance direction of the molding belt.

It has been found that a further improvement in the longitudinal orientation is achieved if the paddle elements have a V-shaped sectional configuration, whereby the wood strands are caused to slide toward a neighboring disk, where the strands comes to stop against the disk. As a result, the last degree of freedom of motion is eliminated and the wood strands lie with all three axes in a defined position on the paddle element.

### BRIEF DESCRIPTION OF THE DRAWINGS

In order that the invention may be clearly understood, it will now be described in connection with example embodiments, with reference to the accompanying drawings, wherein:

FIG. 1 is a side view of a strand depositor head according to the invention for depositing a cover or outer layer of strands on a molding belt for producing OSB panels, wherein the head cooperates with a strand dosing container, with distribution rollers, and with a strand chamber roller mechanism;

FIG. 2A shows on an enlarged scale, compared to FIG. 1, a top plan view in the direction of the arrow II in FIG. 1 illustrating, for example, three alignment chamber rollers according to the invention;

FIG. 2B illustrates, on an enlarged scale compared to FIG. 1, a side view into the alignment chambers formed in the present chamber rollers;

FIG. 3A shows the entry of a strand into a chamber formed by paddle elements between two disks;

FIG. 3B is a side view similar to that of FIG. 3A and shows how the leading edge of a strand has contacted a paddle element whereby the strand is not yet fully oriented in the respective chamber;

FIG. 3C is a view similar to FIGS. 3A and 3B with a strand fully oriented and resting on a paddle element in its chamber; and

FIG. 3D shows how most of a strand length has already slid off the paddle element and with the leading strand edge already resting on the molding belt.

### DETAILED DESCRIPTION OF A PREFERRED EXAMPLE EMBODIMENT AND OF THE BEST MODE OF THE INVENTION

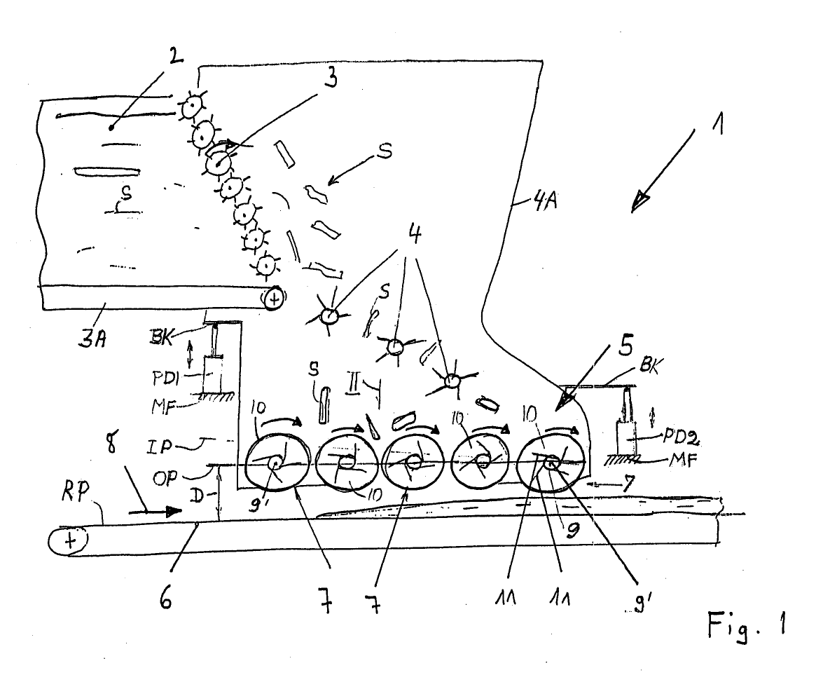

FIG. 1 shows schematically a side view of a panel molding station 1 with a wood strand supply bin 2 that functions as a dosing device. The output end of the supply bin 2 is formed by a strand discharge roller mechanism 3. Strands S are transported by a dosing conveyor 3A to the discharge roller mechanism 3. The strands S fall, by gravity, onto a strand distribution roller set 4 within a housing 4A. The roller set 4 distributes the strands S onto a strand alignment mechanism or head 5 that comprises a plurality of rotation shafts 9 having longitudinal rotational axes 9′ arranged in parallel to one another. A molding conveyor belt 6 is positioned below the rotation shafts 9. The upper run of the molding conveyor belt 6 forms a reference plane RP.

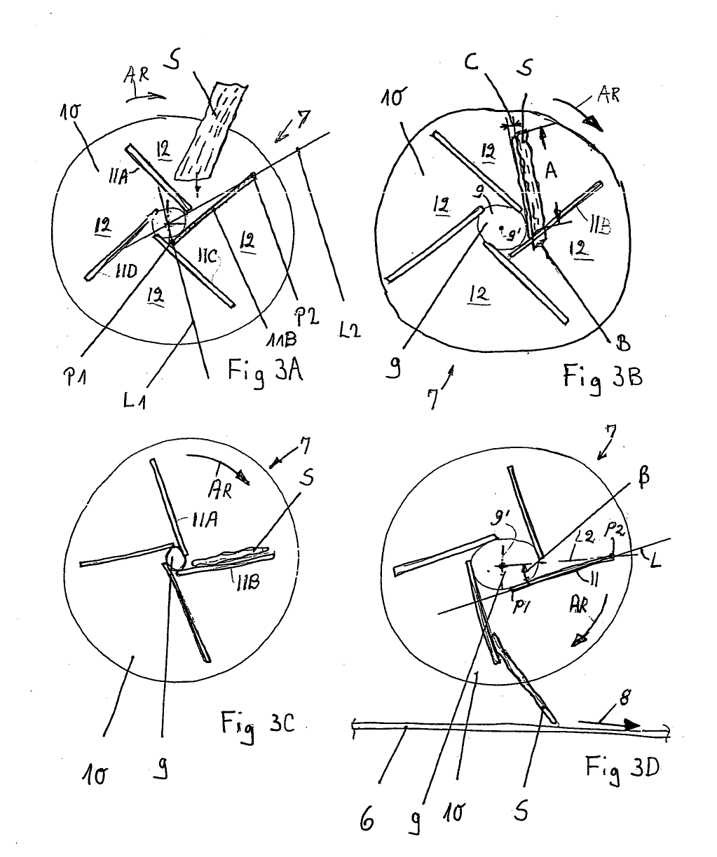

As shown, the rotational shaft axes 9′ are horizontally aligned in an orientation plane OP which is spaced from the reference plane RP by a distance D. A plurality of position adjustment devices PD1, PD2 support the housing 4A in a machine frame MF. The position adjustment devices PD1, PD2 may, for example be piston cylinder devices, rack and pinion devices, pneumatic devices or any other displacement devices suitable for lifting and/or tilting the housing 4A relative to the reference plane RP to adjust the distance D. The piston cylinder devices PD1, PD2 shown as an example, are effective on the housing through brackets BK or the like. If both piston cylinder devices PD1 and PD2 are operated in synchronism with each other, the distance D can be adjusted vertically up or down. In that case the orientation plane OP remains horizontal. However, it is also possible to tilt the housing 4A about a housing journal axis that may, for example coincide with the rotation axis 9′ of the rotation shaft 9 of a first or leading alignment roller 7 or chamber roller 7. Four additional alignment or chamber rollers 7 are shown in FIG. 1. The last alignment roller 7 is the trailing roller as viewed in the feed advance direction 8 of the molding conveyor belt 6. Downstream of the discharge rollers 3 and above the orienting rollers 7 the strands S are randomly oriented in the flow of strands. The flow of strands transports a multitude of elongated flat wood strands S generally having a length A, a width B and a thickness C with the dimensions indicated above. Please see in this connection FIG. 3B. The wood strands S in the bin 2 have already been treated with an adhesive suitable for the formation of the above described OSB panels.

The chamber or alignment rollers 7, five of which are shown in FIG. 1, rotate with a uniform constant rotational speed as indicated by the arrows showing that the rollers rotate in the clock-wise direction. The ends of the rotation shaft 9 of each roller 7 are suitably mounted in the housing 4A that can be lifted and lowered to change the distance D as described above if both position adjustment devices PD are operated in synchronism. However, the housing 4A can also be tilted by operating the left-hand position adjustment device PD1. For this purpose the right-hand position adjustment device PD2 must not interfere with the tilting motion of the housing 4A. For this purpose, the device PD2 must move its piston down while the device PD1 moves its piston up. For this purpose the upper piston rod ends are pivoted to the brackets BK. The rotational axes 9′ of the rotation shafts 9 of the alignment or chamber rollers 7 are then aligned in an inclined plane IP. The inclined plane IP is shown as a dashed line in FIG. 1.

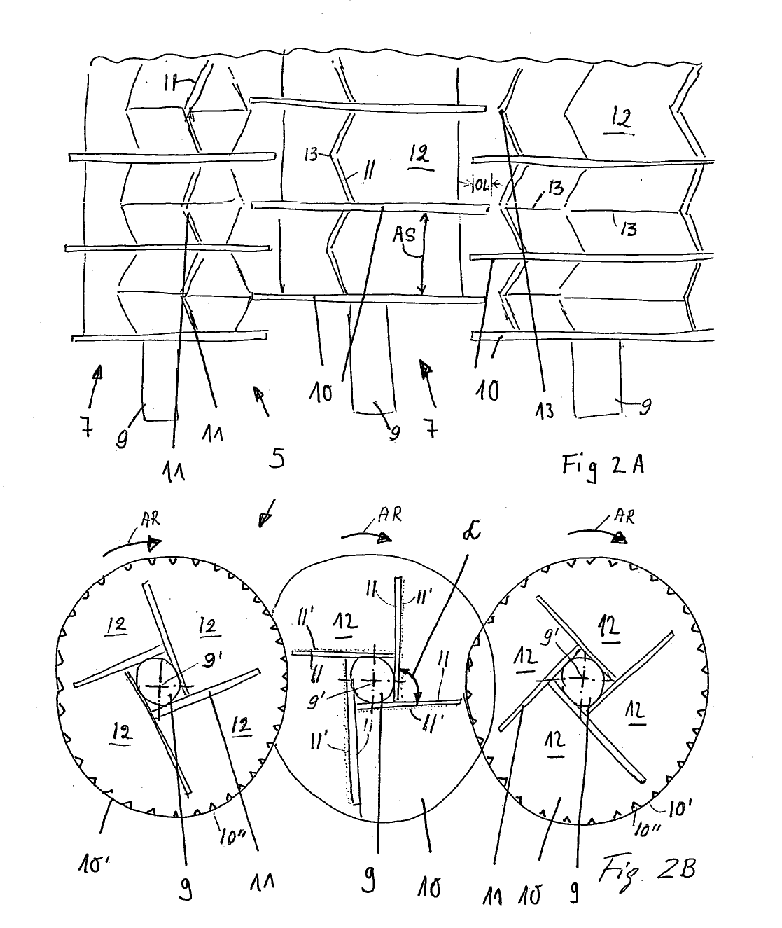

Each chamber or alignment roller 7 comprises a plurality of axially spaced vertically oriented disks 10. The spacing between neighboring disks 10 in the axial direction is uniform on all of the rollers 7. However, the disks 10 of neighboring rollers 7 may be staggered as best seen in FIG. 2A. Further, in another embodiment the spacings between neighboring disks may be narrower from roller to roller in the feed advance direction 8. Such an arrangement of disks 10 helps separating narrower strands from wider strands which all may have substantially the same length. In the shown embodiments all disks 10 have the same outer diameter. However, the disks 10 may also have differing diameters. Incidentally, the staggering of the disks as shown in FIG. 2A has the advantage that the formation of so-called strand tracks is avoided on the finished boards.

According to the invention the channels formed between the axially spaced disks 10 are divided by paddle elements 11 to form pass through chambers 12 best seen in FIG. 2B. In the example embodiment shown in FIG. 2 four chambers 12 are formed by four paddle elements 11 between two neighboring disks 10. More specifically, each channel formed between neighboring disks is provided with the paddle elements 11 according to the invention to form the chambers 12 substantially in a V-configuration best seen in FIG. 2B. In the shown example four paddle elements 11 form a set of four chambers 12. However, three or more paddle elements may be used in each channel between two neighboring disks 10. The paddle elements 11 are, in one embodiment, rectangular pieces of sheet metal which interconnect two neighboring disks 10. These paddle elements 11 extend tangentially to the respective rotation shaft 9 around the rotation axis 9′. The outer ends of the paddle elements 11 reach outwardly, but stop short of the outer rim 10′ of the respective disk 10. In the shown example of FIG. 2B with four paddle elements 11, the circumferential distribution of the paddle elements around the respective rotation shaft 9 is such that an angle α of 90° is formed between neighboring paddle elements 11, as shown in FIG. 2B.

Embodiments of the invention not shown in detail could, for example comprise a different number of paddle elements 11 and thus a different number of pass through chambers 12. Further, the arrangement of the paddle elements 11 could be modified. Rather than positioning the paddle elements 11 tangentially relative to the rotation shaft 9, the paddle elements could be arranged radially relative to the rotation axis 9′. Further, the individual paddle elements 11 could be modified instead of the flat or V-shaped sectional configurations, the individual paddle elements 11 could be shaped convex or concave or their surface texture may be modified for example with a tacky coating 11′ as shown in FIG. 2A.

The illustrated paddle elements 11 have a length that is shorter than the outer diameter of the respective sheet metal disks 10. However, these paddle elements 11 may also have a length so dimensioned that their radially outer ends are flush with the outer rim 10′ of the respective disk 10. In yet another embodiment the paddle elements 11 may have a length such that the elements protrude radially outwardly of the respective disks 10.

As shown in FIG. 2A, the chamber rollers 7 may be so arranged relative to each other that the disks 10 of neighboring rotation shafts 9 are staggered in the axial direction and that in the feed advance direction 8 there is an overlap OL between neighboring disks 10 as best seen in FIG. 2A. The staggering is preferably such, that the disks 10 of one roller 7 are aligned with the center of the pass through channels formed by the disks 10 of neighboring rollers 7. FIG. 2A shows, for example, that the disks 10 are aligned with the ridge 13 of the V-cross sectional configuration of the paddle elements 11.

By making an axial spacing AS between neighboring disks 10 narrower than the length A of the wood strands S, the strands are prevented to assume a crosswise orientation when the strands fall into the pass through chambers 12 between neighboring disks 10. Strands S which do not directly fall into any of the chambers 12 are set into motion or transported, whereby the strands S change their orientation until they are approximately oriented with a longitudinal axis of the molding belt 6 to then fall into a chamber 12.

As shown in FIG. 2B, the orientation of the strands is facilitated by providing the circumferential disk rim 10′ with a structurized surface while leaving the rim surface of the intermediate disk 10 smooth or unstructured. The structurizing may include small protrusions 10″ or a knurled or otherwise roughened rim surface for increasing the effectiveness of the disks 10 on the aligning of the strands S.

Referring to FIGS. 3A, 3B, 3C and 3D, the longitudinal orientation or alignment of the wood strands S will now be described with reference to the timed sequence imposed by the continuous clockwise rotation of the chamber rollers 7. The continuous or constant rotation of the rollers 7 is indicated by the clockwise arrows AR. To facilitate the illustration, only one wood strand S is shown.

In FIG. 3A the strand S is about to fall into a chamber 12 formed between paddle elements 11A and 11B and two neighboring disks 10. As the roller 7 rotates, at least one chip will fall into each of the four chambers 12.

As the rollers 7 keeps rotating as shown in FIG. 3B, the leading edge of the chip S has contacted the paddle element 11B. As the roller 7 keeps rotating in the direction of the arrow AR, the strand S comes temporarily to rest on the paddle element 11B as shown in FIG. 3C. In the position of FIG. 3C the strand S assumes a flat longitudinal orientation on the paddle element 11B. The only deviation that a strand can assume relative to a complete longitudinal alignment, is a slight rotated position within the chamber 12. For example, if the strand is slightly wider in its width than the spacing AS between two neighboring disks 10, the strand can assume a tilted position between the neighboring disks 10.

As the roller 7 continues to rotate, the strand S will slide off the respective paddle element 11 and the leading end of the strand S will contact the surface of the molding conveyor belt 6. The strand S is guided by the disks 10 forming the respective pass through chamber until the trailing end of the strand has cleared the radially outer end of the respective paddle element 11 and also the rim 10′ of the respective disks 10 forming the chamber 12.

The just described guiding of the strands S by the lateral disks 10 and by the respective paddle element 11 makes sure that the leading end of the strand S always contacts the molding belt 6 first. At the moment of contact between the leading strand end and the molding belt 6 the strands S are first subjected to a braking action or to an accelerating action, depending on the relative speed between the leading strand end and the belt 6. Then the strand S is pulled off the paddle element 11 at the speed of the molding belt 6. Depending on the arrangement and/or form of the paddle elements 11 and on the speed of the molding belt 6, the speed of the strand S just prior to the impact of its leading end on the belt 6, can be smaller or larger than the feed advantage speed of the belt 6.

The paddle elements 11 always extend from an inwardly located point P1 to an outwardly located point P2. More specifically, the point P1 defines the inner end of a paddle element 11 while the outer point P2 defines the outer end of the respective paddle element 11. Point P1 is located on a line L1 that extends radially through the center of rotation axis 9′ of the respective rotation shaft 9. Similarly, point P2 is positioned on a line L2 that also passes through the center of rotation axis 9′ of the respective rotation shaft 9. As viewed in the rotational direction of the arrow AR, the line L1 forms a leading line and the line L2 forms a trailing line. FIG. 3D also shows that the line L2 which passes through the outer end point P2 and through the rotation axis 9′, encloses an angle β between a line L that passes through the points P1 and P2 and thus lengthwise through the respective paddle element 11. The angle β can be varied by changing the position of the end points P1 or P2 and by the shape of the paddle element between its end points P1 and P2. With these variations it is possible to select the rotation angle or point at which the wood strand S begins to slide off the respective paddle element 11.

Once a strand S has reached the position shown in FIG. 3D, it will be completely deposited on the molding conveyor belt 6 which travels continuously in the direction of the arrow 8.

As described above, in order to achieve a desirable thickness of strands S on the belt 6 it is advantageous to adjust the spacing D and/or the inclination plane IP of the alignment mechanism or head 5 shown in FIG. 1. The spacing D must, in any event, be selected depending on the type and size of the strands S so that when a strand slides off a paddle element 11 out of the chamber 12, the strand will still be temporarily supported with its trailing end by the respective paddle element.

Referring again to FIG. 2A the paddle elements have a V-sectional configuration such that the ridge lines 13 extend along the entire length of a respective paddle element 11. The ridge line 13 forms the highest point from which the sides of paddle element 11 slope away from the ridge line 13 toward the neighboring disks 10 to form a divided chamber 12 so to speak. A divided chamber 12 assures that the wood strand will slide either to the left or to the right toward one or the other of the two disks 10 forming the divided chamber together with the paddle element 11. Thus, the stands S are forced to rest against one or the other lateral disk 10 of a chamber 11, whereby the position of the strands is defined in all three directions of possible motions in space.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. An apparatus for longitudinally aligning elongated strands for producing panels, said apparatus comprising a strand alignment head (5) including a plurality of rotation shafts (9) arranged in parallel to one another, a plurality of disks (10) mounted on each rotation shaft (9) of said plurality of rotation shafts, said disks (10) being oriented at a right angle relative to a longitudinal shaft axis (9′) and axially spaced from each other along a respective rotation shaft of said plurality of rotation shafts, two neighboring disks forming a strand alignment channel thereby providing a plurality of alignment channels, said apparatus further comprising a plurality of paddle elements (11) mounted between said neighboring disks, said plurality of paddle elements (11) forming strand alignment pass through chambers in said plurality of alignment channels.

2. The apparatus of claim 1, comprising four paddle elements (11) mounted between each of two neighboring disks.

3. The apparatus of claim 2, wherein said four paddle elements (11) are uniformly spaced circumferentially around the respective rotation shaft (9).

4. The apparatus of claim 1, wherein each paddle element (11) of said paddle elements has an inner end (P1) and an outer end (P2) relative to said rotation shaft (9), said inner end (P1) being positioned on a first line (L1) extending radially through said longitudinal shaft axis, said outer end (P2) being positioned on a second line (L2) extending radially through said longitudinal shaft axis, whereby each of said paddle elements (11) extends tangentially relative to said rotation shaft (9).

5. The apparatus of claim 4, wherein each tangentially extending paddle element (11) encloses an angle (β) with said second line (L2) extending radially through said rotation shaft (9).

6. The apparatus of claim 5, wherein said angle (β) is within an angular range of 150 to 45°.

7. The apparatus of claim 4, wherein each of said tangentially extending paddle elements (11) is tilted opposite to a rotation direction so that said outer end (P2) trails said inner end (P1) of each paddle element (11).

8. The apparatus of claim 1, wherein each paddle element of said plurality of paddle elements extends radially relative to said rotation shaft.

9. The apparatus of claim 1, wherein said plurality of disks (10) have a given disk diameter and wherein said plurality of paddle elements have such a length that each paddle element is within said given disk diameter.

10. The apparatus of claim 1, wherein said disks (10) on said plurality of rotation shafts (9) are axially displaced from shaft to shaft so that in a feed advance direction said disks are out of alignment with each other, whereby alignment channels become narrower in said feed advance direction.

11. The apparatus of claim 1, wherein said disks (10) on one rotational shaft comprise a structured, rough rim (10′), and wherein said disks on another rotational shaft extending alongside said one rotational shaft comprise a smooth rim.

12. The apparatus of claim 11, wherein rotational shafts with disks having textured, rough rims, alternate in a feed advance direction (8) with rotational shafts with disks having smooth rims.

13. The apparatus of claim 1, wherein said paddle elements (11) have a V-shaped sectional configuration.

14. The apparatus of claim 1, wherein said paddle elements have an adhesive stick-to coating (11′) facing said elongated strands.

15. The apparatus of claim 1, further comprising means (PD1, PD2) for adjusting a position of said alignment mechanism relative to a reference plane (RP).

16. The apparatus of claim 15, further comprising a molding belt (6) having an upper run and a lower run, said upper run defining said reference plane (RP).

17. The apparatus of claim 1, wherein said disks have stepped outer diameters so that certain disks have diameters that differ from diameters of certain other disks.
